(19) United States
(12) Patent Application Publication
(10) Pub. No.: US 2008/0241680 A1
(43) Pub. Date: Oct. 2, 2008

(54) Pouch type lithium secondary battery

(75) Inventors: Jae Bong Lee, Seongnam-si (KR); Young Jae Kim, Chungju-si (KR); Jae Kook Jeong, Chungju Si (KR); Gyu Sik Kim, Cheongwon-gun (KR); Won Sob Eom, Nam-gu (KR); Hee Min Um, Chungju Si (KR)

Correspondence Address: D. PETER HOCHBERG CO. L.P.A., 1940 EAST 6TH STREET, CLEVELAND, OH, 44114, US

(73) Assignee: Saehan Enertech, Inc., Chungju-si (KR)

(21) Appl. No.: 12/079,115

(22) Filed: Mar. 25, 2008

(30) Foreign Application Priority Data
Mar. 26, 2007 (KR) 10-2007-29085

(51) Int. Cl. H01M 2/02

(52) U.S. Cl. 429/185; 29/623.2

(57) ABSTRACT

A pouch type lithium secondary battery includes a crude cell equipped with electrode leads and electrode tabs, a battery case for sealing the crude cell, and insulating materials provided on an inner surface of the battery case in which the electrode leads and the electrode tabs are disposed. In a method of fabricating a pouch type lithium secondary battery comprising a crude cell equipped with electrode leads and electrode tabs, and a battery case for sealing the crude cell, the battery case is comprised of a first receiving portion for receiving the crude cell and a second receiving portion for receiving the electrode leads. The method includes the steps of processing insulating materials on an inner surface of the second receiving portion, inserting the crude cell into the battery case, and sealing the battery case.

### CROSS-REFERENCE TO RELATED APPLICATIONS

This application claims foreign priority to Korean Patent Application Serial No. 10-2007-29085, filed on Mar. 26, 2007, the content of which is incorporated by reference herein in its entirety.

### BACKGROUND OF THE INVENTION

1. Field of the Invention

The present invention relates to a pouch type lithium secondary battery, and more particularly, to a pouch type lithium secondary battery in which an insulating material is provided on an inner surface of a battery case of the pouch type secondary battery in which electrode leads and electrode tabs of a crude cell are disposed, thus prohibiting an oxidization reaction between an electrolyte and the battery case and preventing any damage to the battery case, which may occur when receiving the crude cell in the battery case.

2. Background of the Related Art

In recent years, with the growth and diversified developments of the information communication industry, there has been an increasing need for lithium secondary batteries. Research has been done into lithium secondary batteries that are able to satisfy a variety of needs accordingly. One of the important subjects that should be supplemented by the lithium secondary batteries is long-term stability of the batteries. In particular, when a pouch type lithium secondary battery using an aluminum-based battery case is used for several months, a swelling phenomenon, which is an expansion phenomenon of the battery due to internal oxidization of the battery case, and a leakage phenomenon are generated.

FIG. 1 is a diagram showing a typical pouch type lithium secondary battery using a general battery case. The conventional pouch type lithium secondary battery 10 is formed using a method of winding a positive electrode and a negative electrode, respectively, using separators through a process called a winding method or a stacking method of laminating the separators, the positive electrode and the negative electrode in the stack structure while maintaining a predetermined distance therebetween. In the methods, after a crude cell 20, i.e., a collection of unit cells is fabricated, the crude cell 20 is received in a receiving portion 31 of a battery case 30 that receives the crude cell 20 and the crude cell 20 is covered with a battery case cover 32. Here, the positive electrode and the negative electrode of the crude cell 20 are coupled to electrode leads 40 and the electrode leads are coupled to electrode tabs 50 and exposed outside.

A space between the receiving portion 31 and the battery case cover 32 is sealed. An electrolyte is inserted into the space, completing the lithium secondary battery. Here, resin layers 51 are formed at portions where the electrode tabs 50 and the battery case 30 are connected in order to secure sealing with the pouch.

Meanwhile, a general battery case is described with reference to FIG. 2. An aluminum-based battery case 70 includes several layers. A thin film type aluminum layer 71 that maintains the pouch shape is formed at the center layer of the battery case 70, and a film 72 that protects the aluminum layer from external air and stimulus is formed on the outermost side. A polypropylen-based resin layer 73 that prevents a reaction between an electrolyte and aluminum, and a sealant layer 74 fused by heat in order to seal the pouch are sequentially disposed on the inner side of the aluminum layer, i.e., the inside of the battery. When fabricating the pouch type lithium secondary battery, the aluminum-based battery case is made of a soft packaging material and has a concave space in order for the crude cell to be easily received therein. The space is molded into a shape corresponding thereto. The crude cell is received in the battery case, covered with a cover and then sealed with a sealant layer by applying heat to the outside of the battery case.

Meanwhile, when fabricating the conventional pouch type lithium secondary battery, there is a problem in that the protruded portions of the electrode leads 40 and the electrode tabs 50 give damage to the battery case 30 within the battery due to external shock or when the crude cell 20 is received, thus exposing the aluminum layer. Further, the aluminum layer can be exposed due to the occurrence of micro pinholes in the resin layer, damage to the pouch and so on, which are caused by the influence of heat used to seal the pouch. Even in a completed pouch type lithium secondary battery, the battery case can be damaged due to the movement of the electrode leads 40 caused by drop, shock, pressure, compression, etc. In this case, aluminum constituting the aluminum layer reacts with the electrolyte for the lithium secondary battery, so gas is generated within the battery and a swelling phenomenon in which the battery is expanded is generated. In particular, when sealing the battery case, a top end portion 34 of the receiving portion, which is located (comes in contact with) corresponding to the electrode leads 40, does not correspond to the electrode leads 40, but is sealed by applying higher heat and greater pressure to the battery case 33 coming in contact with the cover in order to seal the pouch type lithium secondary battery by melting the resin layer 51 adhered to the electrode leads 40. In this case, not only the sealant layer 74, but also the resin layer 73 that protects the aluminum layer can be melted. Consequently, aluminum constituting the aluminum layer reacts with the electrolyte for the lithium secondary battery, so gas is generated within the battery and a swelling phenomenon in which the battery is expanded is generated. Further, the protruded portions of the electrode leads 40 and the electrode tabs 50 damage the battery case within the battery due to external shock or when the crude cell is seated, thereby resulting in a problem that the aluminum layer is exposed outside. Accordingly, there is an urgent need for a technology that is able to protect the battery case of the pouch type lithium secondary battery using the aluminum-based battery case.

### SUMMARY OF THE INVENTION

Accordingly, the present invention has been made in view of the above problems occurring in the prior art, and it is an object of the present invention to provide a pouch type lithium secondary battery in which an insulating material is provided on an inner surface of a battery case of the pouch type secondary battery, which corresponds to electrode leads and electrode tabs of a crude cell, thereby prohibiting an oxidization reaction between an electrolyte and the battery case and preventing damage to the battery case, which may occur when the crude cell is received in the battery case.

To achieve the above object, a pouch type lithium secondary battery according to the present invention includes a crude cell equipped with electrode leads and electrode tabs, a battery case for sealing the crude cell, and insulating materials provided on an inner surface of the battery case in which the electrode leads and the electrode tabs are disposed.

The battery case comprises a first receiving portion for receiving the crude cell and a second receiving portion for receiving the electrode leads. The insulating materials are provided on the inner surface of the second receiving portion.

The insulating material includes an insulating tape or insulating resin. The insulating tape may be formed by adhering a film type insulating tape, which is selected from the group consisting of polyethylene, epoxy film, polyimide film, Teflon, polyvinyl chloride, polyester, acetate film, filament film, asbestos film, paper film and polypropylene having thermal endurance and chemical resistance, using any one adhesive selected from acryl base, silicon base and rubber base. The insulating resin may include any polymer resin selected from the group consisting of silicon base, ceramics, alumina, epoxy, polyimide, polyvinyl chloride, polyester, acetate and polypropylen.

The insulating resin may range from 0.001 to 5 mm in thickness.

The insulating materials may be disposed on an inner circumference of the second receiving portion or a cover portion.

According to the present invention, there is provided a method of fabricating a pouch type lithium secondary battery comprising a crude cell equipped with electrode leads and electrode tabs, and a battery case for sealing the crude cell, wherein the battery case is comprised of a first receiving portion for receiving the crude cell and a second receiving portion for receiving the electrode leads, the method includes the steps of processing insulating materials on an inner surface of the second receiving portion, inserting the crude cell into the battery case, and sealing the battery case.

### BRIEF DESCRIPTION OF THE DRAWINGS

Further objects and advantages of the invention can be more fully understood from the following detailed description taken in conjunction with the accompanying drawings in which:

FIG. 1 is a schematic diagram of a conventional pouch type lithium secondary battery;

FIG. 2 is a sectional view of a conventional aluminum battery case;

FIG. 3 is a sectional view of a pouch type lithium secondary battery according to a first embodiment of the present invention;

FIGS. 4a to 4e are schematic diagrams of a pouch type lithium secondary battery according to a preferred embodiment of the present invention; and

FIG. 5 is a schematic diagram illustrating oxidization acceleration experiments with respect to the pouch type lithium secondary battery of the present invention.

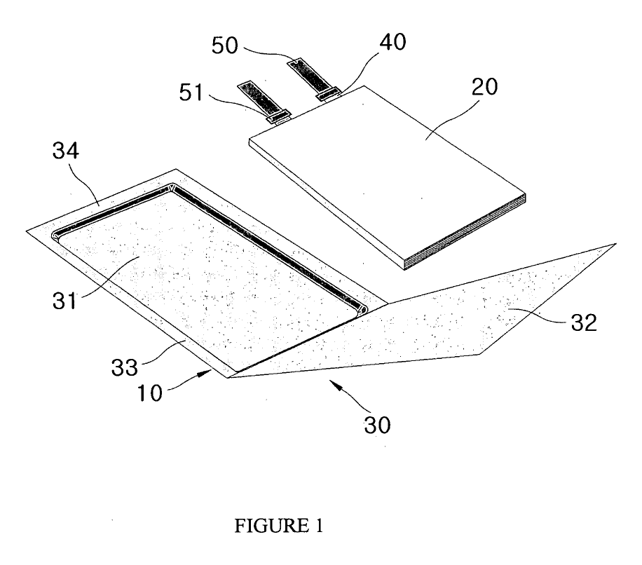

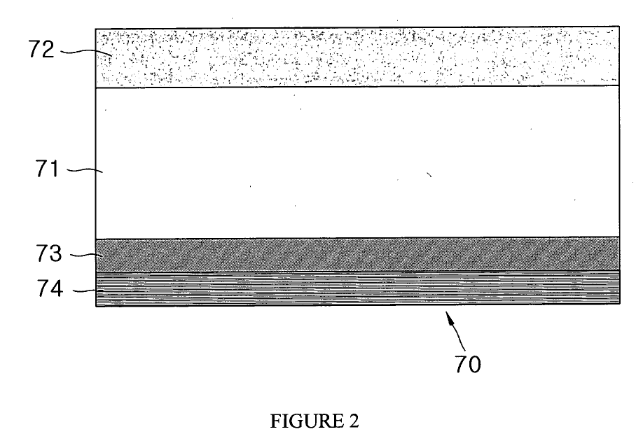

### DETAILED DESCRIPTION OF THE PREFERRED EMBODIMENT

The present invention will now be described in detail in connection with specific embodiments with reference to the accompanying drawings.

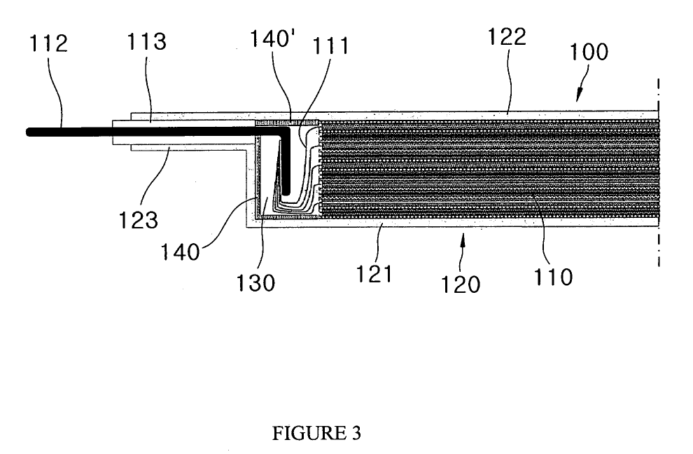

FIG. 3 is a sectional view of a pouch type lithium secondary battery according to a first embodiment of the present invention.

Referring to FIG. 3, a pouch type lithium secondary battery 100 according to a preferred embodiment of the present invention has a structure of a positive plate/a separator/a negative plate, and includes a crude cell 110 comprising electrode leads and electrode tabs, and a battery case 120 in which the crude cell 110 can be received and sealed. The crude cell 110 can be theoretically a lithium secondary ion battery or a lithium secondary polymer battery. The crude cell 110 can be a unit cell itself, a Bi-cell itself or a stack of several unit cells or Bi-cells. Each electrode plate (the positive plate or the negative plate) comprises a plate body and a grid protruded from the plate body.

The grid is divided into a positive lead and a negative lead. The positive lead and the negative lead can be arranged in opposite directions to the length direction of the crude cell 110. However, in the present embodiment, it is assumed that the positive lead and the negative lead are disposed in the same direction to the length direction of the crude cell and the positive lead and the negative lead are collectively referred to as electrode leads 111. The electrode leads 111 are connected to electrode tabs 112, which are protected by a resin layer 113. This structure is identical to that of a typical crude cell.

The battery case 120 for receiving the crude cell 110 is divided into a receiving portion 121 for receiving the crude cell 110 and a cover portion 122 for covering the receiving portion. The receiving portion is equipped with a first receiving portion for receiving the main body of the crude cell 110, i.e., a receiving portion occupied by the crude cell 110, a second receiving portion 130 for receiving the electrode leads 111 and part of the electrode tabs 112 connected to the electrode leads 111, and a sealing portion 123 corresponding to the resin layer 113.

Meanwhile, the present invention relates to processing of an inner surface of the electrode leads and the battery case corresponding to the electrode tabs using insulating materials, and more particularly, to processing of the inner surface of the second receiving portion 130 (i.e., an inner side surface of the second receiving portion 130) using insulating materials 140, 140′. Specifically, if all or part of the inner surface of the second receiving portion 130 is processed using the insulating materials, it can prevent a swelling phenomenon generated by the reaction of the electrode leads and the battery case.

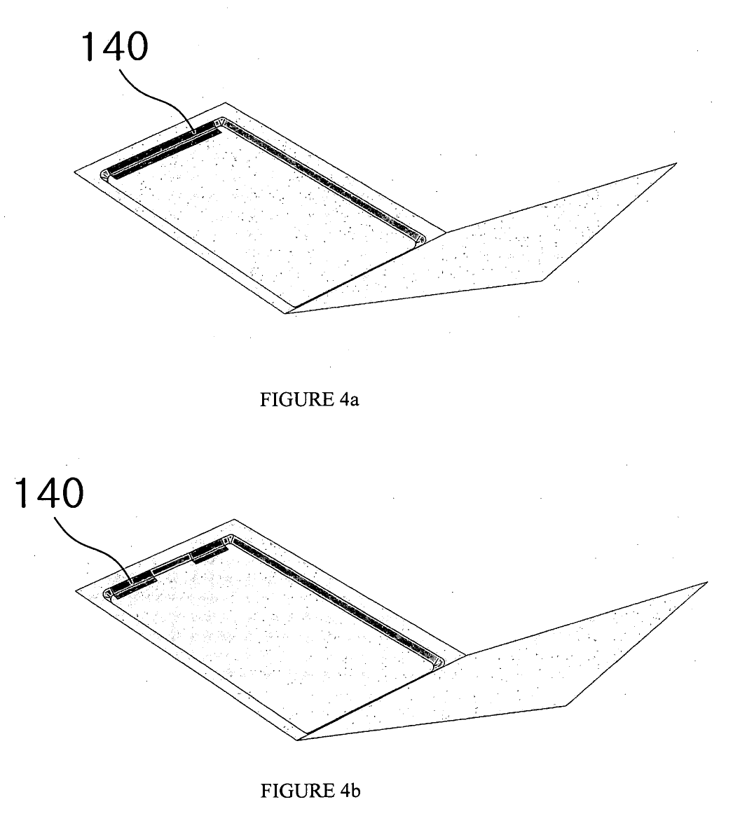

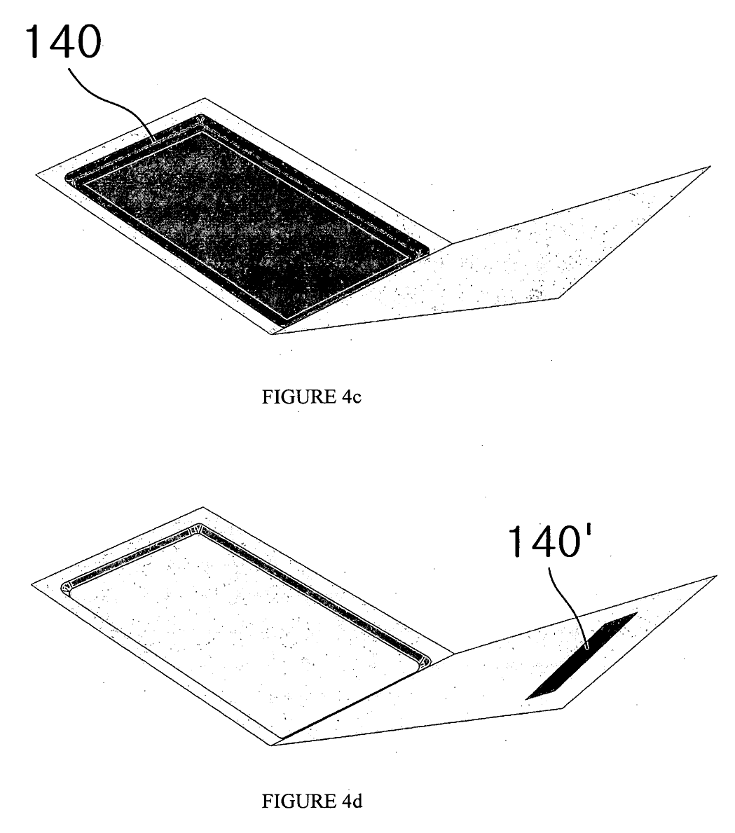

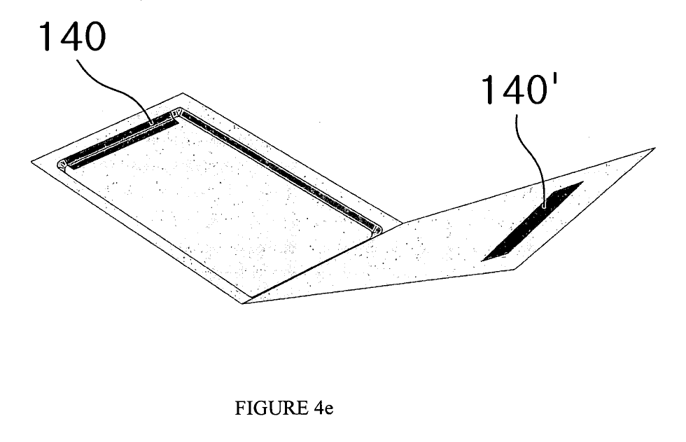

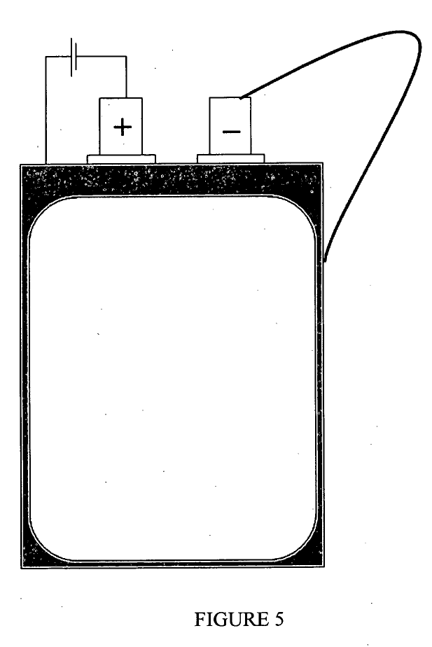

Meanwhile, portions processed by the insulating materials include all or part of the second receiving portion, as illustrated in FIGS. 4a to 4e. More specifically, an inner circumference of the second receiving portion 130 can be processed in a “ [symbol] ” form as illustrated in FIG. 4a, or only portions corresponding to the positive/negative electrode leads of the inner circumference of the second receiving portion 130 can be processed using the insulating material as illustrated in FIG. 4b. Alternatively, the entire receiving portion can be processed using the insulating materials as illustrated in FIG. 4c, the cover portion of the second receiving portion can be processed using the insulating materials as illustrated in FIG. 4d, or both the inner circumference and the cover portion of the second receiving portion can be processed using the insulating materials as illustrated in FIGS. 4e.

Meanwhile, it is preferred that the sealing portion 123 coming in contact with the resin layer 113 is not processed using the insulating materials. In particular, if the sealing portion 123 is processed using insulating tapes, there is a high possibility that the insulating materials can be melted or sealing is not properly performed.

The insulating materials used in the present invention can include any kinds of insulating materials if they prevent contact and reaction between the electrode leads and the battery case. It is preferred that the insulating materials employ insulating tapes or insulating resin.

More specifically, the insulating tape can be used by adhering a film type insulating tape, which is selected from the group consisting of polyethylene, epoxy film, polyimide film, teflon, polyvinyl chloride, polyester, acetate film, filament film, asbestos film, paper film and polypropylene having thermal endurance and chemical resistance, using any one adhesive selected from acryl base, silicon base and rubber base.

The insulating resin can employ any polymer resin selected from the group consisting of silicon base, ceramics, alumina, epoxy, polyimide, polyvinyl chloride, polyester, acetate and polypropylene. A dilution concentration, the type of a solvent agent and so on of the insulating resin are identical to those of a typical insulating resin. The thickness of the insulating resin is identical to that of the insulating tape, preferably, in the range of 0.001 to 5 mm. Meanwhile, the insulating resin can be coated using a typical coating method. The insulating resin is sealed and used after performing a sufficient dry process.

Hereinafter, the present invention is described in detail in connection with the following embodiments. The following embodiments of the present invention are only illustrative and the scope of the present invention is not limited to the embodiments.

### EXAMPLE 1

As shown in FIG. 4a, a typical crude cell (Saehan Enertech, Inc.) was received in the battery case in which the insulating tape made of polyester was adhered on the inner circumference of the second receiving portion and then sealed, fabricating the pouch type lithium secondary battery.

### EXAMPLE 2

The pouch type lithium secondary battery was fabricated in the same manner as Example 1, except that the silicon-based resin was coated instead of the insulating tape.

### COMPARATIVE EXAMPLE 1

The pouch type lithium secondary battery was fabricated in the same manner as Example 1, except that the insulating tape was not adhered.

### EXPERIMENTAL EXAMPLE

pouch type lithium secondary batteries of each of Embodiments 1 to 2 and Comparative Example 1 were fabricated and oxidization acceleration experiments were performed on the pouch type lithium secondary batteries. The experimental results are illustrated in Tables 1, 2. More specifically, gas is generated at the micro pinholes and damaged portions of the battery case within the battery due to oxidization by the reaction of the aluminum-based battery case of the pouch type lithium secondary battery and the electrolyte for the lithium secondary battery, so a swelling phenomenon in which the battery is expanded is generated. It is thus difficult to measure such oxidization by the naked eyes, using other measurement devices, etc. before the battery is expanded. Further, it takes a long time to notice the oxidization. If the amount of electrons flowing through the battery case is increased, the oxidization can be accelerated and the results thereof can be checked rapidly. Experiments were carried out by flowing a high potential through the battery case in order to accelerate oxidization in a state where the negative leads of the pouch type lithium secondary battery charged up to 4.2V were connected to the aluminum layer of the battery case, as shown in FIG. 5. A total of 30 batteries were fabricated and results depending on whether swelling had been generated according to a lapse of time were listed in Table 1.

TABLE 1

| | | date | | | | | | | | | |
|---|---|---|---|---|---|---|---|---|---|---|---|
| | | 1 | 2 | 3 | 4 | 5 | 6 | 7 | 8 | 9 | 10 |
| Number of | Example 1 | 0 | 0 | 0 | 0 | 0 | 0 | 0 | 0 | 0 | 2 |
| battery | Example 2 | 0 | 0 | 0 | 0 | 0 | 0 | 0 | 0 | 0 | 3 |
| having | Compara- | 0 | 0 | 3 | 9 | 10 | 11 | 11 | 13 | 14 | 14 |
| swelling | tive | | | | | | | | | | |
| (accumulated | Example 1 | | | | | | | | | | |
| number) | | | | | | | | | | | |

From Table 1, it can be seen that in the batteries of Examples 1 and 2 of the present invention, the swelling phenomenon was rarely generated. However, in Comparative Example 1, the swelling phenomenon was generated starting from the third date and the swelling phenomenon was generated in about half the batteries in the tenth date.

As described above, according to the present invention, a swelling phenomenon caused by the reaction of the aluminum-based battery case and the electrolyte for the lithium secondary battery can be prevented and damage to the battery case, which may occur when receiving the crude cell, can be prevented. Thus, the lithium secondary battery can be used stably for a long period of time. Further, damage to the battery case, which may occur because the electrode tabs are moved due to external factors such as drop, compression and shock when the lithium secondary battery is used, can be prevented. Thus, the stability of the lithium secondary battery can be increased.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

We claim:

1. A pouch type lithium secondary battery comprising:
a crude cell equipped with electrode lea&s and electrode tabs;
a battery case for sealing the crude cell, said battery case having an inner surface; and
insulating materials provided on said inner surface of the battery case, wherein the electrode leads and the electrode tabs are disposed in said battery case.

2. The pouch type lithium secondary battery according to claim 1, wherein the battery case comprises a first receiving portion for receiving the crude cell and a second receiving portion for receiving the electrode leads, said second receiving portion comprising an inner circumference, an inner surface and a cover portion, and wherein the insulating materials are provided on the inner surface of the second receiving portion.

3. The pouch type lithium secondary battery according to claim 1, wherein the insulating material is selected from the group consisting of an insulating tape and an insulating resin.

4. The pouch type lithium secondary battery according to claim 3, wherein the insulating tape is formed by adhering a film type insulating tape, which is selected from the group consisting of polyethylene, epoxy film, polyimide film, teflon, polyvinyl chloride, polyester, acetate film, filament film, asbestos film, paper film and polypropylene having thermal endurance and chemical resistance, using any one adhesive selected from the group consisting of acryl base, silicon base and rubber base.

5. The pouch type lithium secondary battery according to claim 3, wherein the insulating resin includes any polymer resin selected from the group consisting of silicon base, ceramics, alumina, epoxy, polyimide, polyvinyl chloride, polyester, acetate and polypropylene.

6. The pouch type lithium secondary battery according to claim 3, wherein the insulating resin comprises a thickness in the range from 0.001 to 5 mm.

7. The pouch type lithium secondary battery according to claim 2, wherein the insulating materials are disposed on the inner circumference of the second receiving portion or the cover portion of the second receiving portion.

8. A method of fabricating a pouch type lithium secondary battery comprising a crude cell equipped with electrode leads and electrode tabs, and a battery case for sealing the crude cell, wherein the battery case is comprised of a first receiving portion for receiving the crude cell and a second receiving portion for receiving the electrode leads, said second receiving portion comprising an inner surface, the method comprising the steps of
processing insulating materials on said inner surface of the second receiving portion;
inserting the crude cell into the battery case; and
sealing the battery case.
